(19) United States
(12) Patent Application Publication
(10) Pub. No.: US 2021/0386236 A1
(43) Pub. Date: Dec. 16, 2021

(54) FACEPLATE FOR IMPROVED EXTRACTION OF BEVERAGE MATERIAL

(71) Applicant: Nexe Innovations Inc., Surrey (CA)

(72) Inventors: Darren Joseph Footz, Surrey (CA); Kianoush Karimi Pour Kerman, Vancouver (CA)

(21) Appl. No.: 17/346,934

(22) Filed: Jun. 14, 2021

Related U.S. Application Data
(60) Provisional application No. 63/038,541, filed on Jun. 12, 2020.

(51) Int. Cl. A47J 31/06; A47J 31/40

(52) U.S. Cl. CPC A47J 31/0631; A47J 31/407; A47J 31/0642

(57) ABSTRACT

The present disclosure is directed methods for making and to features that may be included in a single-use beverage dispensing container. Such containers are commonly referred to as beverage pods. Such beverage pods are commonly used in offices and in residences where individuals wish to make a single cup of coffee, tea, chocolate, or other beverage. Features that may be included in beverage pods of the present disclosure include an agitation device that redirects a flow of a fluid injected into the beverage pod when a beverage is made. This redirected fluid flow may increase an amount of turbulence within a beverage pod such that soluble materials like a chocolate powder are more effectively dissolved into the fluid, or this turbulence may increase the efficiency of extracting materials from non-soluble beverage making materials such as coffee or tea.

### CROSS-REFERENCE TO RELATED APPLICATIONS

The present disclosure claims priority benefit of U.S. provisional patent application 63/038,541 filed on Jun. 12, 2020, the disclosure of which is incorporated by reference herein.

### BACKGROUND OF THE INVENTION

### Field of the Invention:

The present disclosure relates to single-serve beverage cartridges. More specifically the present disclosure is directed to improved beverage cartridges. The present disclosure further relates to methods of manufacture and uses thereof.

### Description of Related Art:

Single-serve beverage cartridges have become a dominant method for serving beverages, especially hot beverages, in a variety of settings such as homes, offices, waiting rooms, hotel rooms and lobbies, and other places where people consume beverages. The rapid growth of single-serve beverage cartridges is driven by consumer preference for convenient, quickly prepared beverages in single-portion quantities, in a variety of flavors, beverage types (coffee, espresso, decaffeinated coffee, tea, decaffeinated tea, cider, hot cocoa/chocolate, bone broth, and even alcoholic beverages, such as, for example, Irish Coffee, Hot Toddy, Hot Buttered Rum, etc.). Even within a beverage type, such as coffee, there may be a plurality of roasts and associated roasters, flavor profiles, flavor additives, caffeine strengths, location or locations of origin, etc.

The convenience and variety of single serving beverage cartridges allows and encourages consumers to prepare and consume a plurality of beverages throughout the day. This pattern of consumption causes the rapid accumulation of used beverage cartridges wherever they are consumed. Due to the nature of single-serving beverage cartridges, a considerable amount of packaging waste is produced per beverage consumed compared to preparing beverages by traditional means, such as, for example, preparing a plurality of servings at once using bulk ingredients. Packaging waste, according to the United States Environmental Protection Agency (EPA), defines containers and packaging as products that are assumed to be discarded the same year the products they contain are purchased. The EPA further estimates that the majority of the solid waste are packaging products. Packaging waste contributes significantly to global pollution, the introduction of contaminants into the natural environment that cause adverse change, which poses a health risk many forms of life, including humans, other animals, plants, fungi, etc.

Single-serve beverage cartridges typically comprise several components made of various materials. The typical components of a single-serve beverage cartridge include, at least, a container, typically made from plastic such as polyethylene, a filter, typically made from plant fiber such as abaca fibers or other natural and synthetic fibers, and a container lid, typically made from food-grade aluminum foil, which is also commonly printed upon to include product labelling. Some beverage cartridges do not contain a filter, typically because the beverage material is readily soluble in hot water (such as, for example, hot cocoa). The container will usually comprise an opening on the top of the container, and a hollow cavity within which and across which a filter may be disposed. The container may also comprise an opening at on the bottom container. After the filter and beverage material are inserted into the container, the lid is then typically sealed over the container opening or openings. The sealed lid typically provides an airtight seal, preventing the exchange of gases between the environment and the interior of the container, thus preventing oxidation and/or spoilage of the beverage material.

In beverage cartridges that comprise a filter, the filter may separate the container into two chambers: a first chamber occupying the space within the container between the filter and the opening of the container, the first chamber for holding dry beverage ingredients such as, but not limited to, coffee, tea, or cocoa, for a single beverage serving; and (ii) a second chamber occupying the space within the container between the filter and the base of the container, the second chamber being on the opposite side of the filter to the first chamber. The purpose of the second chamber is typically to provide a space in which a fluid extractor of a beverage brewing device may be inserted into the bottom of the container, entering the second chamber and allowing the extraction of fluid from the cartridge without the fluid extractor entering the first chamber, such that fluid must flow through the beverage material and the filter before exiting the cartridge via the fluid extractor. However, the presence of the second chamber may significantly reduce the space within the container that can be occupied by beverage medium. This may be problematic as the total amount of beverage material disposed within the container may significantly contribute to the final concentration of the beverage, typically measured in Total Dissolved Solids (TDS). It may be advantageous to minimize the volume of the second chamber in order to maximize the volume on the first chamber, thereby maximizing the total volume available for beverage material. However, the fluid extractor is typically comprised of a sharp, hollow needle-like piercing element designed to easily pierce through the bottom of the container, such that if the second chamber is reduced in size, the fluid extractor may penetrate or damage the filter, allowing the beverage material to exit the first chamber, and ultimately exit the cartridge via the fluid extractor. Thus, in the event the fluid extractor penetrates or damages the filter, grains of the beverage material may be transported into the final beverage, which may be undesirable to consumers (such as, for example, the presences of coffee grounds in a prepared cup of coffee) and may potentially damage the beverage brewing machine (for example, by way of clogging the fluid extractor with beverage material).

a cover or lid is typically disposed over an opening of the container (which may be, for example, over the top of the container, and/or bottom of the container). This cover helps keep the dry beverage ingredients within the container and often provides airtight seal to prevent oxidation and other types of degradation of the container's contents. In practice, a single-serving beverage cartridge is placed into a compartment of a brewing machine. The machine is activated such that a fluid injector penetrates the cover of the cartridge and a fluid extractor penetrates the base of the cartridge, which may also be covered with a second cover. The fluid injector injects a brewing medium (e.g. hot water) into the first chamber for extracting beverage components from the ingredients. The brewing medium containing the extracted beverage components percolates through the filter and into the second chamber. The brewing medium containing the extracted elements and flavors is then extracted by the fluid extractor and finally dispensed as a drinkable beverage.

Currently, single-server beverage cartridges are typically made from petroleum-based plastic materials that are neither biodegradable nor compostable. In some cases, the container may be made of petroleum biodegradable materials, such as polybutylene adipate terephthalate (PBAT). While these materials may eventually biodegrade, they are not desirable for use in home or industrial composting settings, as they may pollute the compost with petroleum residue, micro-plastics, and other chemicals that may not be desirable for compost. Composting is the mixing of various decaying organic substances, such as dead plant matter, which are allowed to decompose to the point that various waste products of the composting process provide nutrients to be used as soil conditioners/fertilizers. Composting can be aerobic, anaerobic, and/or vermicomposting, depending on the environment in which the compost is prepared. Aerobic composting is the decomposition of organic matter by microbes that require oxygen to process the organic matter. The oxygen from the air diffuses into the moisture that permeates the organic matter, allowing it to be taken up by microbes. Anaerobic composting is the decomposition of organic matter by microbes that do not require oxygen to process the organic matter. To be anaerobic, the system typically must be sealed from the air, such as with a plastic barrier. Anaerobic compositing produces an acidic environment to digest the organic material. Vermicomposting is the decomposition of organic matter by worms and other animals/insects (such as soldier flies). A portion of the organic matter is converted to vermicast, or castings from the worms or other animals. The breakdown of the organic matter into vermicast yields an effective soil conditioner and/or fertilizer.

The cover/lid of a beverage pod is typically made of a metal foil (e.g., aluminum) or a metal foil laminate which is glued to the top of the container. Generally, neither the metal foil of the cover nor the glue affixing the cover over the opening of the container is biodegradable, compostable or made from readily renewable resources. As a result, non-biodegradable and non-compostable beverage cartridges typically end up in landfills, thereby at least contributing to environmental concerns associated with disposal of trash. This may be especially problematic due to the fact that traditional means of brewing beverages, e.g., using solely beverage material and filter material, or a filtration device (such as a French press, or a wire mesh filter) may yield a completely compostable waste product (e.g., spent coffee grounds and potentially a used paper filter).

Attempts have been made to recycle plastic beverage pods in some cases. Recycling has many issues which effect the efficacy and practicality of these programs. The first is collection and transportation. Collection largely requires voluntary compliance by consumers. Some deposit programs encourage consumers to return recyclable materials, however this accounts for very few recyclable materials. Collection is further complicated by the need to further transport the materials to a facility which can process them. Many of these facilities are run by municipalities as recycling operations frequently lack economic viability without government subsidies. Recycling of plastics and other materials is further complicated by cross contamination and downcycling. Cross contamination is the presence of foreign materials not desired in the end product and can include materials such as other non-recyclable waste, or other recyclable wastes not compatible with the desired recycled material which can include other plastics. This requires sorting and cleaning of materials. This process can be partially automated, however it also requires manual sorting and inspection which adds cost, reduces the amount of material that can be processed and inevitably results in a less pure product than when using virgin material. This frequently results in downcycling.

Downcycling is the term used to describe the reduction of quality in recycled materials compared to materials prior to being recycled. Impurities introduced during processing, from non-recyclable waste that could not be removed, or from other plastics and materials can make the resulting material unsuitable for use in their original applications. As such, the applications for recycled materials, especially plastics, are limited, as is the number of times that plastics can be recycled.

Beverage containers, such as instant beverage cups or pods, are particularly difficult to recycle. Not only do they have non-recyclable material contained within them that would first need to be removed, they are frequently comprised of at least two different materials, such as a plastic cup and an aluminum foil lid. When the lid is made of plastic, it is often a different type than the cup, and would require separation prior to processing when being recycled. This increases the complexity of the recycling operation, requiring at least three separate streams for each type of refuse, each requiring their own preparation. Furthermore, the small size of these beverage pods creates a disproportionate amount of effort required to recycle a small amount of material. The separation of materials would ideally be performed by the consumer prior to recycling, however, this inconvenience will inevitably result in consumers recycling the beverage containers without proper preparations, or failing to recycle the container at all, electing to discard the container as trash. One of the major advantages of using beverage pods is consumer convenience, such that a beverage can be prepare by simply inserting a cartridge into a machine that performs all other brewing functions. It is therefore undesirable to instruct consumers to disassemble and sort various materials from the beverage pod, and due to the diminutive size of beverage pods, this may not be physically possible for consumers without fine motor skills necessary to disassemble such an item. The result is a required step of preprocessing the containers before they can be recycled to ensure the materials are separated and the recyclable material sufficiently cleaned.

Plastics are traditionally sourced from petroleum. They are processed with chemicals to create polymers which can then be formed into shapes. Such polymers that are heated to be formed and then hold their shape when cooled are called thermoplastics. Many of the chemicals used to produce these polymers are inherently toxic and can leech into the contents. This is why few types of plastics are approved for use with foods. Some materials may be safe storing some types of food products, such as dry goods, however when a solvent is introduced, the chemicals in the plastic can go into solution. In the past, some plastics that were previously approved for use with foods have been found to leech chemicals, such as BPA (Bisphenol A). Other chemicals that can be found in plastics include thalates, antiminitroxide, brominated flame retardants and poly-fluorinated chemicals. Depending on the chemical and the manner in which the plastic is being used, it can cause problems including irritation in the eye, vision failure, breathing difficulties, respiratory problems, liver dysfunction, cancers, skin diseases, lung problems, headache, dizziness, birth defects, as well as reproductive, cardiovascular, genotoxic and gastrointestinal issues.

There has been a push from some governments to mandate composting and increase the amount of recycled material to reduce the amount of waste being incinerated or buried in landfills. Some laws such in the European Union, set specific targets, such as 65% of waste recycled by 2035. In the United States, there is no national law, but roughly half of states have some form of recycling law and municipalities may further add to these laws resulting in a varying patchwork of regulations and mandates. Some laws are very limited, requiring that some bottles and cans be recycled. Many of these states also add deposits to bottles, adding monetary value and incentive to returning them for recycling. Others require only specific recyclable materials be recycled, while others may be permitted to be discarded in the trash. Some states go further, mandating that compostable waste be disposed of properly, either in a home composter, or via an industrialized composting operation.

A further complication to composting plastics is that not all plastics break down the same. Some plastics, whether petroleum based or bioplastics, which originate from biomass, are biodegradable. Only a small subset of these are also compostable. The distinction lies in how quickly the plastic breaks down, and whether the process of degradation releases harmful chemicals into the environment. Compostable plastics typically degrade within 12 weeks, wherein biodegradable plastics will typically break down within 6 months. Ideally, compostable plastics would break down at the same rate as common food scraps, about 90 days.

Another class of plastics are OXO-degradable plastics. These are different than biodegradable plastics in that they are traditional plastics with additional chemicals which accelerate the oxidation and fragmentation of the materials under UV light and/or heat. This allows the plastics to break down more quickly, however the result is pollution from micro-plastics, as the plastic molecules themselves do not degrade any faster than their traditional plastic counterparts. There have been efforts in some jurisdictions to ban these plastics.

When brewing coffee, the concentration of the final product is impacted by variables including heat, duration, and surface area of the coffee grounds in contact with the brewing fluid, typically water. While heat and duration are more easily controlled, the surface area of the coffee grounds in contact with the brewing fluid is more difficult to control as the material can become compacted, can clump unexpectedly, or may become mostly suspended in the brewing fluid. Each of these scenarios will result in a final product with different qualities resulting in an inconsistent experience.

When a soluble material is used in a beverage pod, agglomeration can occur which can prevent the entirety of the beverage material from being dissolved in the brewing fluid. When agglomeration occurs, it can also cause malfunctions including clogging the outlet.

Proper mixing is required for brewing both soluble and non-soluble beverage materials. In a traditional beverage container or pod, the brewing fluid injected in the pod is intended to provide sufficient agitation to the beverage material. Unfortunately, this can have an inconsistent result, particularly when the beverage material has had time to settle in the beverage pod. What are needed are new methods and apparatus that increases the efficiency of dissolving soluble beverage materials or that increases the efficiency of extracting elements from non-soluble beverage materials.

### SUMMARY OF THE PRESENTLY CLAIMED INVENTION

The present disclosure is directed to an apparatus for making a beverage using single-serve beverage containers that are also referred to as beverage pods. The present disclosure is also directed to methods for making beverage containers and for making beverages using beverage containers with certain specific structural elements. In a first embodiment an apparatus includes a container that houses a beverage making material. This apparatus may also include a structure located in the container that changes a direction of a fluid provided into the container. The change in direction of the fluid agitates the beverage making material into a beverage that is expelled from the container after the agitation of the beverage making material.

In a second embodiment, a method for making a beverage container includes forming a container case and adding a structure into the container case. Here the structure may be disposed in the container case to change a direction of a fluid is provided to the container case. Next the method may include adding a beverage making material into the container case. When the fluid is provided to the container case, the fluid mixes with the beverage making material making the beverage based on the changed direction of the fluid.

In a third embodiment, a method for making a beverage may include changing a direction of a fluid provided to a single-serve beverage pod by a structure included on an internal portion of the single-serve beverage pod when the fluid is provided to the single-serve beverage pod. Here the fluid mixes with the beverage making material when the fluid is provided to the single-serve beverage pod based on the changed direction of the fluid. The mixing of the fluid with the beverage making material makes a beverage. The beverage may then be output from the single-serve beverage pod.

### BRIEF DESCRIPTIONS OF THE DRAWINGS

FIG. 1 depicts a block diagram of a compostable beverage pod or container of the present disclosure.

FIG. 2 illustrates an agitation device that may be included in a beverage pod when the beverage pod is manufactured.

FIG. 3 illustrates how liquid may flow past or through an agitation device.

FIG. 4 illustrates yet another configuration of a beverage pod agitation device.

FIG. 5 illustrates a series of steps that may be performed when a beverage pod that includes an agitation device is made.

FIG. 6 illustrates steps for method for making a beverage using a beverage pod that includes an agitation device.

FIG. 7 illustrates a beverage pod that includes some features that are different from the beverage container of FIG. 1.

### DETAILED DESCRIPTION

The present disclosure is directed methods for making and to features that may be included in a single-use beverage dispensing container. Such beverage pods are commonly used in offices and in residences where individuals wish to make a single cup of coffee, tea, chocolate, or other beverage. Features that may be included in beverage pods of the present disclosure include an agitation device that redirects a flow of a fluid injected into the beverage pod when a beverage is made. This redirected fluid flow may increase an amount of turbulence within a beverage pod such that soluble materials like a chocolate powder are more effectively dissolved into the fluid, or this turbulence may increase the efficiency of extracting materials from non-soluble beverage making materials such as coffee or tea. Apparatus of the present invention may increase efficiency and quality of beverages. The addition of a properly designed agitation device to a beverage pod will increase turbulence of a brewing fluid injected into a beverage pod. This will help improve the distribution of beverage material in the brewing fluid, thereby, improving efficiency of a brewing process. This may also result in a more consistent final product the added turbulence will more effectively penetrate beverage materials, even when those materials have been compacted. Additionally, the increased turbulence reduces the likelihood of agglomeration occurring with soluble beverage material, similarly reducing the likelihood of failure or inefficient brewing.

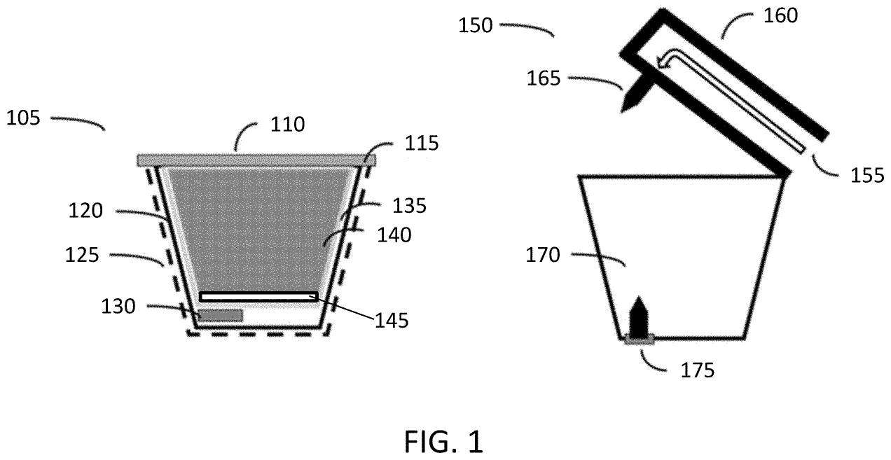

FIG. 1 depicts a block diagram of a compostable beverage pod or container of the present disclosure. The beverage container or pod 105 of FIG. 1 includes lid 110, bonding location 115, casing 120, optional outer coating 125, filter guard 130, filter 135, beverage materials 140 located inside of filter 135, and agitation device 145. FIG. 1 also illustrates beverage extraction/brewing machine assembly 150 used to extract elements included in a beverage container when a fluid is introduced into a brewing/extraction chamber 170. This fluid may be provided to the extraction/brewing assembly from fluid source 155 and through the beverage materials included in the beverage container. The beverage machine assembly 150 of FIG. 1 includes fluid source 155, extraction/brewing assembly chamber lid 160, brewing/extraction chamber 170, piercing element/nozzle 165 that receives fluid from fluid source 155, and outlet 175 that may also include an element that pierces a bottom portion of a beverage container.

In operation chamber lid 160 the beverage machine 150 would be opened, beverage cartridge 105 would be placed into chamber 170, chamber lid 160 would then be closed, and a button may be pressed to initiate the flow of a fluid (e.g. water) from fluid source 155 through piercing element/nozzle 165. The closing of lid 160 could force piecing elements of nozzle 165 and outlet 175 to pierce respectively a top part and a bottom part of beverage cartridge 105. Filter guard 130 of beverage cartridge 105 may help prevent the piercing element of outlet 175 from reaching or piercing filter 135. Here the liquid flowing from fluid source 155 would flow through piercing nozzle 165 into the top of beverage cartridge 105, through filter 135, beverage materials 140, agitation device 145, and out of outlet 175 when a beverage is made.

Beverage pod/cartridge 105 of FIG. 1 may include one or more of, a beverage medium that is either soluble or insoluble, one or more filters, and a first portion in which liquid is passed into and a second portion through which liquid passes out of the cartridge. In some instances, portioned beverage packages contain a water-soluble material, to make a drink such as hot chocolate, chai tea, etc. These portioned packages can be pouches as well as pods for beverage brewing machines. Beverage cartridges can contain a number of components, including pod lid, capsule lid, or cartridge lid. The lid of a beverage pod is often made of foil that may be glued to a bottom portion of a cartridge to seal a beverage material inside of the cartridge.

Cartridge lid 110 of FIG. 1 may be comprised of a compostable natural material, for example, a spun bond environmentally friendly plastic web film material (e.g., a material including polylactic acid (PLA), any polymer selected from the class of polymers known as polyhydroxyalkanoates (PHAs) (such as polyhydroxybutyrate (PHB), or a combination thereof), a cellulose paper film, or other type of compostable nonpolluting material. Lid 110 may be bonded to an upper portion/bonding location 115 of casing 120. In certain instances, filter 135 may be bonded to an internal surface of casing 125. These bonds may be a mechanical or chemical bond. Here a mechanical bond may be created using heat sealing or ultrasonic welding and a chemical bond may be created using a food grade adhesive. The bonding of a lid or a filter onto or into a case may include creating bods at in one location or may include several separate bonds at different locations of a case. A filter bond may be a type of capsule bond that binds the filter medium to a portion of the capsule. Here again this may include ultrasonic welding, adhesives, or thermal sealing. A capsule may include an exterior surface that is includes a series of holes, that includes portions of a filter element, or may be a filter material similar to a tea bag that contains a material for making a beverage.

While the beverage pod of FIG. 1 is discussed as including filter 135, in certain instances, a filter may not be used, for example, when the beverage making material is soluble. In such an instance beverage making material 140 may be placed in beverage container/pod 105 without filter 135. While FIG. 1 illustrates the agitation device 145 being located at a bottom portion of beverage container/pod 105, agitation device 145 may be placed anywhere within a beverage container or pod. As such an agitation device may be placed at a top portion, at a middle portion, or at a bottom portion of a beverage pod or may be placed within a filter that includes the beverage making material. In certain instances, agitation device 145 may be part of, attached to, or be bonded to an interior portion of a beverage pod. When the agitation device is attached to the interior of the beverage pod, it may be attached by a friction fit, may be attached using a food grade adhesive, or may be bonded using heat or ultrasonic bonding.

The process of manufacturing beverage cartridge 105 may include coating exterior portions of cartridge 105 with a coating 125 material. Coating 125 may have been applied as part of process where the coating is sprayed onto outer surfaces of cartridge 105. Alternatively, cartridge 105 may be placed into a mold and the coating 125 may be extruded into the mold when external surfaces of cartridge 105 are coated.

The exterior of cartridge 105 can be made of a non-polluting plastic (such as PLA, PHAs, PHB, or combinations thereof), cellulose, etc. Combinations of various materials (that may include PLA, PHA, PHB, or cellulose) have some properties that are similar to properties of petroleum based thermoplastic polymers (e.g. polypropylene (PP), polyethylene (PE), and polystyrene (PS)) and have other properties that are different from most petroleum based thermoplastic polymers. What this means is that items made from PLA, PHAs, PHB, and/or cellulose can have the look and feel of “plastic,” yet biodegrade over a span of weeks or months, where items made from PP, PE, and PS, or other petroleum based thermoplastic polymers may not fully degrade over weeks, months, or even many years. This allows for beverage container made from PE, PHA, cellulose, and or other similar organic materials to serve as a biodegradable alternative to coffee pods made using petroleum based thermoplastic polymers.

PLA and PHA materials are renewable materials that may be produced using bacterial fermentation of sugar or lipids that may have been derived from corn, cassava, sugarcane, or sugar beet pulp. Mechanical properties of PHAs can be modified for a given use case by blending PHA material with other biodegradable polymers, such as PLAs. Other types of biodegradable materials from which plastic may be made include poly-L-lactide (PLLA). PLLAs are also considered to be compostable materials because of how quickly PLAA materials can degrade in the environment. Cellulose materials are made from fibers derived from plant matter. Cellulose may be collected by processing cotton, flax, wood pulp, hemp, and other plant materials. These various materials may be used to fabricate a biodegradable filter material that could be used in coffee or other beverage pods/cartridge. What this means is that non-petroleum based organic materials may be used to form various parts of a beverage cartridge.

Other materials that are biodegradable plastic alternatives include petroleum-based plastics such as, polyglycolic acid (PGA), polybutylene succinate (PBS), polycaprolactone (PCL), polyvinyl alcohol (PVOH) and polybutylene adipate terephthalate (PBAT). In certain instances, these other materials may be used to fabricate a portion of a beverage cartridge, for example, casing 120 of FIG. 1.

Filters included in a cartridge may be made of any of the materials or combination of materials discussed in the present disclosure in order to help insure that the entire cartridge biodegrades within weeks of months after being used. Beverage cartridges can also contain a capsule interior that is separate from a filter, in beverages that have an insoluble beverage material such as coffee. The capsule interior can be used for a number of purposes, including, providing material properties such as structural integrity (e.g., provide addition strength to resist the pressure of liquid injection in the process of brewing a beverage, which may crack or otherwise compromise the beverage pod), or altering the biodegradability or rate of the beverage pod in some embodiments. For example, coating 125 may be a material that alters the biodegradability of materials included in casing 120 or vice versa.

As mentioned above, filter guard 130 is a structure integrated into a beverage pod that prevents a sharp part of outlet 175 from piercing filter 135. In some embodiments, an interior of cartridge 120 may include integrated features to act as a filter guard, removing the requirement for a discrete filter guard 130. Filter 135 may be made from as spun bond PLA webbing material, cellulose paper, cloth, or metal. A main purpose of filter 135 and filter guard 130 is to prevent an insoluble portion of a beverage material from leaving the beverage pod and entering the beverage brewing/extraction machine or a beverage made by a brewing machine. These filters can be symmetrical (e.g., fluted), or asymmetrical (e.g. pleated).

Here a beverage material is the material used to produce a brewed or extracted beverage, such as coffee grounds, tea, or a mix beverage where the beverage material is soluble, such as hot chocolate. Beverage materials may include flavorings, nutritional content (e.g., any oils, nutritional supplements, active ingredients such as pharmaceuticals, cannabinoids, etc.), alcohol, coloring, or any other composition which has an effect on the final beverage. Beverage brewing/extraction machines for making portioned beverages from pre-packed beverage pods exist for a variety of beverages. These beverage materials may include portions that are made insoluble (e.g., coffee) or may include materials that are completely soluble (e.g., hot chocolate mix).

A beverage brewing/extraction machine will typically contain many other components, such as, for example, a heating element, a liquid reservoir or plumbing component, a liquid pump, an exterior chassis, a controller for the brewing process, a display or indicator lights and sounds, a user interface including buttons or a touchscreen, a tray to catch spillage, etc. For the purposes of description, it is assumed a beverage brewing/extraction machine contains all components necessary to accomplish the beverage brewing process, though specific reference to beverage brewing machine components may only be made to those components which come into direct contact with the beverage pod, such as the brewing chamber, a fluid injecting component, and a fluid extracting component. A beverage brewing/extraction machine may include the following elements: A fluid source that supplies 155 a fluid or liquid (usually water) to the brewing machine for producing the desired beverage. A brewing chamber lid 160 that opens to allow a new pod to be added to the machine, and in many of the most common embodiments of a beverage brewing machine, the chamber lid 120 connects the fluid source 155 to the brewing piercing element/nozzle 165. As mentioned above nozzle 165 provides the fluid when a beverage is created. Here again chamber 170 may receive beverage container 105 and a piercing nozzle of output 175 may pierce the bottom of container 105 to allow the created beverage to flow through output 175. Agitation device 145 may direct the flow of fluid such to provide turbulence to either more effectively mix soluble materials with a fluid or to direct a fluid to more effectively extract elements from a non-soluble beverage material such as coffee grounds or tea leaves. While the agitation device 145 of FIG. 1 is illustrated as being located at the bottom of beverage pod 105, it may be place at any location of a beverage pod or may be integrated into the sides of a beverage pod. Such an agitation device may be rigid, flexible and may further be static or moving. In instances when the agitation device moves, this movement may result from the flow of fluid forcing the agitation device to rotate like how a waterfall moves a water wheel.

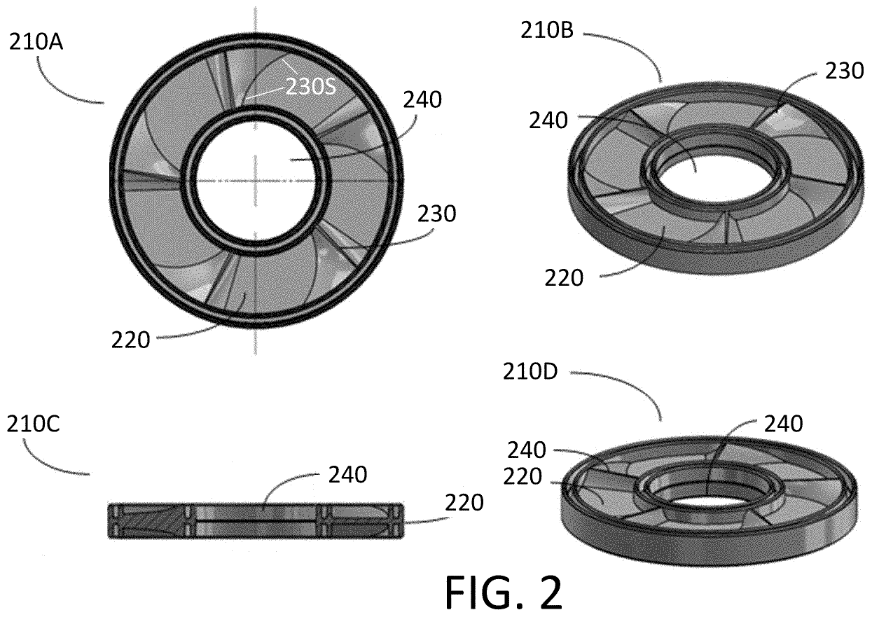

FIG. 2 illustrates an agitation device that may be included in a beverage pod when the beverage pod is manufactured. FIG. 2 illustrates four views 210A, 210B, 210C, & 210D of an agitation device. These views include top view 210A, isometric view 210B, side cross-sectional view 210C, and perspective view 210D. The different views of the agitation device of FIG. 2 include a structure that may be referred to as a faceplate that includes recessions 220 and protrusions 230 disposed on a top surface of the agitation device. The various views of the agitation device may include a drain or hole 240 as can be seen in top view 210A, isometric view 210B, and perspective view 210D. Protrusions 230 may have a curved shape 230S with a wider protruding portion located at an exterior of the agitation device and a narrower protruding portion located near a center portion of the agitation device where drain 240 is located.

Cuts or voids may be located at locations in the faceplate, for example, item 230S may be a cut or void and each similar curved shape in FIG. 2 may also be a cut or void. Such voids will allow fluid to flow much like air flowing through a pinwheel. Here the fluid may be directed to flow in in directions that increase an amount of agitation of a beverage material when a beverage is made.

The agitation device of FIG. 2 may be formed of a single material or a combination of materials including any of polylactic acid (PLA), a polyhydroxyalkanoate (PHA), and natural or composite fibers. The embodiment illustrated in this figure illustrates a turbine design. When a fluid is injected into a beverage pod that includes an agitation device, a flow of that fluid may be redirecting to increase the turbulence of the fluid flow. This may help improve the mixing of the fluid with a beverage material enclosed within the beverage pod. The faceplate is the structure to which at least one protrusion 230 is affixed. The faceplate may be a portion of the beverage pod structure, such as the bottom of the beverage pod or the pod wall.

The faceplate may alternatively be a structure formed separate of the beverage pod. For example, the faceplate may be a disk comprised of PLA and independent of the beverage pod structure. The faceplate may be fused to the filter or beverage pod structure after it is formed or may remain a separate structure. Protrusions 230 may be a feature mounted to the faceplate which rises from the plane of the faceplate into the beverage pod housing a beverage making material. Here again the protrusions may be attached using for example using ultrasonic welding, adhesives, or thermal sealing. Such a faceplate or agitation device will typically include at least one protrusion that is affixed to or included in the faceplate. Here the protrusions 230 and may be arranged randomly or evenly arranged on a faceplate of an agitation device. The protrusion may have a conical shape, a fin-like shape, a blade-like shape, or other shape that directs the flow of a fluid. The protrusion may be irregular in shape and size or may have a uniform shape.

In some instances, a plurality of fin-like protrusions 230 are uniformly arranged in a circular pattern on the faceplate, each fin at an angle to form a turbine-like shape 230S. Upon injection of a fluid into a beverage pod containing the agitation device, the fluid is redirected by the turbine-like shape to create turbulent flow within the beverage pod. This may increase mixing of the beverage material with the fluid. As mentioned above the agitation device may include drain 240 that may be a hole. In certain instances, drain 240 may be a channel or other fluid path build into in the faceplate that allows fluid to pass over the faceplate and escape the beverage pod via drain 240 and a bottom portion of the beverage pod.

In certain instances, there may be more than one drain in an agitation device included in a beverage pod. When the drain is a single hole in the center of the faceplate, a fluid provided to the beverage pod may be directed in a manner that results in turbulent mixing of the fluid and a beverage making material. Note also that the agitation device of FIG. 2 has a shape that may be characterized as toroidal shape. The cross-sectional view 220C of FIG. 2 shows that the agitation device may have disk-like-shaped with a drain in the center of the agitation device. Here the protrusions 230 are fin structures rising from the surface of the agitation device.

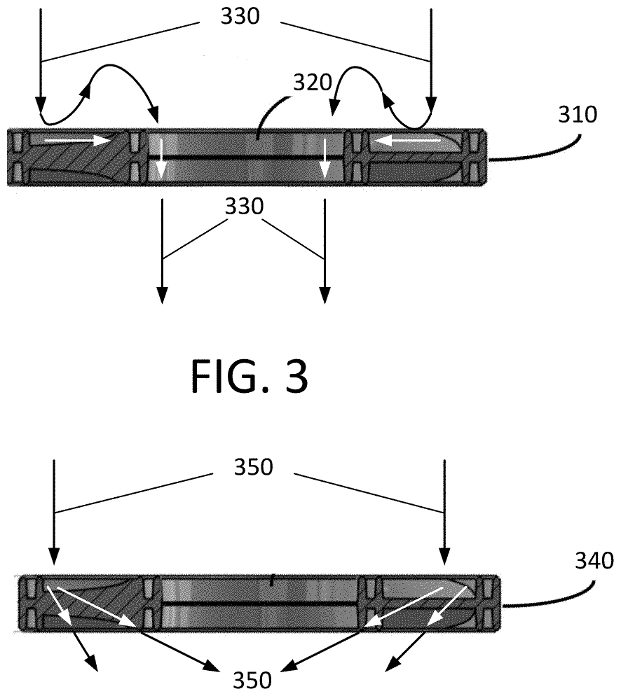

FIG. 3 illustrates how liquid may flow past or through an agitation device. FIG. 3 illustrates two different cross-sectional side views of two different agitation devices 310 and 340. The black and white arrowed lines 330 illustrate how fluid may flow onto a top part of agitation device 310. Here the fluid may flow in a circuitous path around and through agitation device. The 310 flow may impact a top surface of agitation device 310 and flow in a backward/upward direction before passing through hole 320 in agitation device 310. This flow of fluid may also flow along top surfaces of agitation device 310 as shown by the horizontal white arrowed lines of FIG. 3.

Agitation device 340 of FIG. 3 may include holes, cuts, or voids similar to the voids 230S of FIG. 2 that allow the fluid to flow 350 in a directed path through agitation device 340. FIG. 3 shows flow 350 using both black and white arrowed lines, where fluid enters from above agitation 340 device and then through agitation 340 device in various directions illustrated by the arrowed lines 350 that are not perpendicular to the top and bottom surfaces of agitation device 340.

The different agitation devices 310 & 340 illustrated in FIG. 3 may be located in either a top portion, a middle portion, or a bottom portion of a beverage pod. Agitation device 310 when placed at a bottom portion of a beverage pod could agitate a fluid as the fluid moved through the circuitous path of flow 330. Agitation device 340 when placed at a top portion of a beverage pod could direct fluid in various directions when a beverage was made from beverage materials located below agitation device 340. The various agitation devices discussed herein may be used in beverage dispensing apparatus that include one or several different nozzles that provide a fluid to a beverage pod.

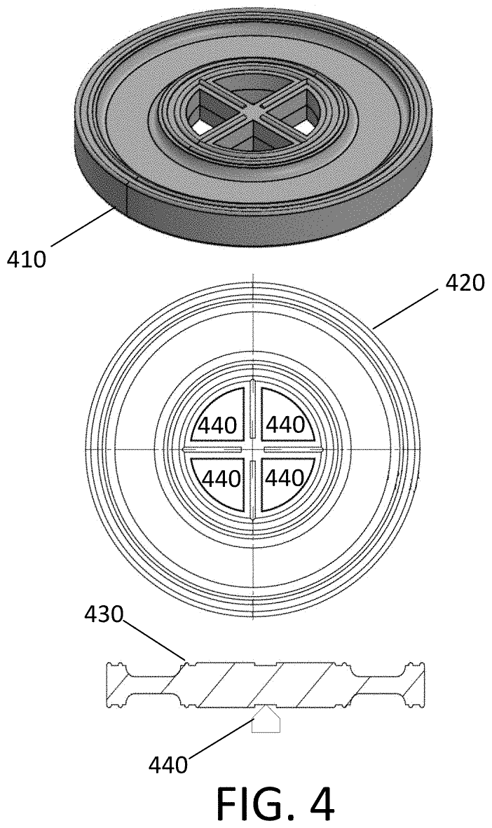

FIG. 4 illustrates yet another configuration of a beverage pod agitation device. FIG. 4 includes perspective view 410, a top view 420, and a side view 430 of a same type of agitation device. The agitation device of FIG. 4 includes four holes located near a center portion. Note that these holes are separated by a portion of the agitation device that looks like a cross or a plus sign.

The side view 430 of the agitation device of FIG. 4 includes a support 440 that may include a protrusion that fits into a recess located at a center portion of the agitation device. This support could allow the agitation device 430 of FIG. 4 to move or rotate as liquid is provided to a beverage pod. A beverage pod agitation device could include a combination of the features discussed in respect to any of FIGS. 2, 3, and 4. For example, an agitation device could include the raised features 230 and curve shapes 230S discussed in respect to FIG. 2, could include voids discussed in respect to FIG. 2 or 3, and could include support 440 of FIG. 4. One or more of these various features could be used to force the agitation device to rotate when a fluid is provided to a beverage pod.

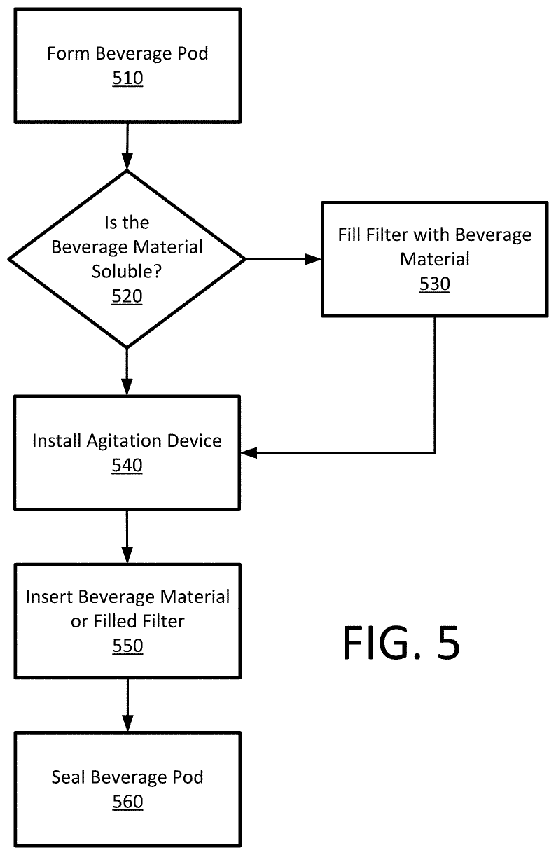

FIG. 5 illustrates a series of steps that may be performed when a beverage pod that includes an agitation device is made. FIG. 5 begins with step 510 where a beverage pod is formed. This may include heating the pod making material and forming that heated material in a form. This pod making material may be a biodegradable thermoplastic material such as PLA or PHA, which may or may not include fibers of natural or composite materials. The forming process may be performed vacuum thermoforming around a form in the shape of a negative space of the beverage pod. The form may alternatively be in the shape of the exterior of the beverage pod. In yet other instances, the pod may be formed via injection molding where a heated thermoplastic material is injected into a mold. After cooling, the thermoplastic material may be cooled such that it retains the shape of the mold.

The pod may also be comprised of natural or composite fibers which may be pressed into a mold. When the pod is formed by vacuum forming using a sheet of PLA over a conical cylinder form, formed pod may further have any excess plastic removed by a cutting instrument that may additionally be heated.

After step 510, determination step 520 may identify whether a beverage making material that will be placed in the beverage pod is soluble or now. When the beverage making material is soluble, program flow may move from step 520 to step 530. Soluble beverage making materials are materials that dissolve into a fluid such as water when a beverage is made. Once dissolved, a solution including the beverage making materials and water will exit the beverage pod. Soluble beverage making materials include substances like of hot cocoa mix, sugar, and a creamer. Non-soluble beverage materials include substances like coffee grounds or tea leaves from which elements like coffee or tea are made bases on an extraction of elements from the coffee grounds or tea leaves.

When the material is non-soluble, a filter may be comprised of a biodegradable material comprising any of PLA, PHA, natural or composite fiber, or a combination of two or more of these materials. In one instance, PLA is heated until melted and is extruded through at least one hole in an extrusion die resulting in at least one strand of thin plastic which is deposited on a plate to cool. A layering of these extrusions, resulting in a mat of threads with a porosity size smaller than that of the grain size of the beverage material, a process known spun or spin bonding. The filter may be loosely placed within the beverage pod or may be bonded to the beverage pod, such as by ultrasonic welding, at step 530 of FIG. 5.

When the beverage making material is a soluble material, program flow may move from determination step 520 to step 540 where an agitation device may be installed in the beverage pod. Program flow may also move to step 540 after step 530.

When the beverage material is non-soluble, the agitation device may be positioned within the filter such that the filter is positioned between the agitation device and the pod wall.

In an instance when the beverage material is soluble, the agitation device may be positioned directly within the pod. Spacers may be inserted to raise the agitation device away from a wall of the pod. The agitation device may be free floating within the pod or bonded to the pod or filter. In certain instances, the agitation device may be formed as part of the beverage pod during the beverage pod forming. Here again, the agitation device may have a disk-like-shape with a faceplate that includes a plurality of fin-like or blade-like protrusions rising from the surface of the faceplate as discussed in respect to FIG. 2. The agitation device may also include at least one hole acting as a drain that makes a drink when a fluid passes by the agitation device.

When the agitation device is installed within a filter inside a beverage pod, it may be arranged such that the protrusions or recessions are facing away from the filter and the bottom of the beverage pod (or visa versa). In other instances, the agitation device may be arranged on the walls of the beverage pod in addition to or as an alternative to being arranged in the bottom of the beverage pod.

The agitation device may alternatively be comprised of a non-soluble agitation media dispersed within the beverage material. Applying a pod lid to the opening of the beverage pod and creating a pod bond between the pod lid creating a sealed unit. After step 540 the beverage making material or a filled filter may be inserted into the beverage pod in step 550 of FIG. 5. Note that a filled filter may be installed into a beverage pod at either step 530 or step 550 of FIG. 5. Furthermore, an agitation device may be installed into or be built into a beverage pod in step 510 of FIG. 5. Next, in step 560 the beverage pod may be sealed. This may include placing a cover over a top portion of the beverage pod and the tope cover may be bonded to the top of the beverage pod. This bond may be formed using heat or an adhesive, or a combination of heat and an adhesive to create a seal.

The creation of a pod bond may be immediately preceded by the addition of a preservative, such as an inert gas to preserve the freshness of the beverage material. The addition of the preservative may alternately be added to the beverage pod in a simultaneously with the application of the pod bond. A pod cover or lid may be made from a biodegradable cellulose paper film which is affixed to the beverage pod using an adhesive pod bond immediately following the addition of nitrogen gas to displace the air within the beverage pod. Here again this gas may act as a preservative to maintain freshness of the beverage making material.

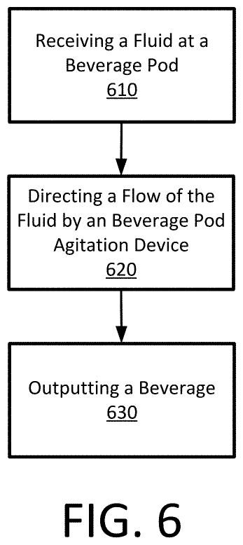

FIG. 6 illustrates steps for method for making a beverage using a beverage pod that includes an agitation device. The flow chart of FIG. 6 begins with a first step where a fluid is received at a beverage pod in step 610. This fluid may have been received after a person placed the beverage pod into a single-use beverage making machine assembly (like assembly 150 of FIG. 1), lid 160 may be closed, and a button to dispense a liquid may be pressed. Next, in step 620, the flow of the fluid may be directed by a beverage pod agitation device located inside of the beverage pod. The directing of the fluid may cause the fluid to agitate and mix with or extract elements from a beverage making material located inside of the beverage pod. After step 620, the beverage made by the directed fluid mixing or extraction may be output from the beverage pod at step 630 of FIG. 6.

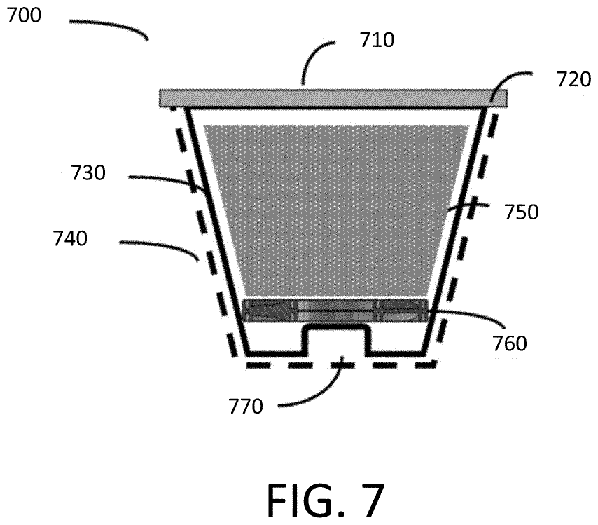

FIG. 7 illustrates a beverage pod that includes some features that are different from the beverage container of FIG. 1. Beverage pod 700 of FIG. 7 includes several features that are similar to beverage container 1-5 of FIG. 1, these features include lid 710, bonding location 720, case 730, and optional coating 740. Beverage pod 700 also includes beverage making material 750, agitation device 760, and dome feature 770. Here again, depending on a type of beverage making material, a filter may or may not be included within beverage pod 700. When a filter is used, the filter may be filled with beverage making material 750 and the filter may simply be placed in the case 740 before lid 710 is attached to case 740. Alternatively, the filter may be bonded to case 740 before beverage pod 700 is sealed. When a filter is used, agitation device 760 may also be placed inside of the filter.

As discussed above, a beverage making material included in a beverage container or pod is a material used to produce a brewed beverage. Here again the beverage making material may be coffee grounds, tea, or a mix beverage where the beverage material is soluble (e.g. hot chocolate). Beverage making material 350 may include any flavorings, nutritional content (e.g., any oils, nutritional supplements, active ingredients such as pharmaceuticals, cannabinoids, etc.), alcohol, coloring, or any other composition which has an effect on a final beverage. As noted above beverage pod 700 includes dimple feature 770 located at a bottom side of beverage pod 700 and a beverage may be made by placing beverage pod 700 in brewing machine assembly 150 of FIG. 1 followed by closing chamber lid 160 and pressing a brew button.

Here again, agitation device is a structure that redirects a flow of a liquid injected into the beverage pod 700 to improve mixing of the beverage material with the liquid. The bottom dimple feature 770 on the bottom of a beverage pod may be a dome or cylindrical deformation of the bottom of the pod exterior which protrudes into the beverage pod such as to create a channel along the outer wall of the beverage pod on the bottom of beverage pod 700. The agitation device may rest on top of the bottom dimple feature and be raised sufficiently away from the bottom of the pod exterior such that the brewed liquid can exit the beverage pod without clogging due to agglomeration.

The bottom dome feature 770 may be formed or molded. Dome feature 770 may provide a space at the bottom of beverage pod 700 of about 3 mm such that sufficient space is created beneath the agitation device to allow a brewed beverage to exit the beverage pod. In some instances, the interior of beverage pod 700 may have integrated features into that serve as agitation device 760. Here again agitation device 760 may have fin-like or blade-like surface features that redirect the flow of fluid in order to increase turbulence of the fluid and perturb or mix the beverage material contained within the pod.

Here again beverage pod 700 the case 730, cape lid 730, agitation device 760, or optional filter may be made of one or more biodegradable or compostable materials. Such biodegradable materials may include a spun bond PLA web film (which may contain a proportion of PHA, in some embodiments), a cellulose paper film, etc. The pod lid 710 is typically the liquid injection point where a brewing pin punctures the pod lid and injects the brewing liquid. In certain instances, pod lid 710 may be made from a cellulose film. The exterior may be made of a biodegradable plastic such as PLA, PHAs, cellulose, or combination of these materials.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim. what is claimed is:

1. An apparatus for making a beverage, the apparatus comprising:
a container that houses a beverage making material; and
a structure located in the container and that changes a direction of a fluid provided into the container thereby agitating the beverage making material into a beverage that is expelled from the container after having been agitated.

2. The apparatus of claim 1, further comprising one or more raised features on a surface of the structure that facilitate the changing of the direction of the fluid.

3. The apparatus of claim 1, further comprising one or more curved shaped voids in the structure that allow the fluid to flow through the structure and that facilitate the changing of the direction of the fluid.

4. The apparatus of claim 1, further comprising one or more holes in the structure that allow the fluid to flow through the structure.

5. The apparatus of claim 1, further comprising a filter that houses the beverage making materials.

6. The apparatus of claim 1, wherein the structure is included within the filter.

7. The apparatus of claim 1, further comprising a support that supports the structure and that allows the structure to move when the fluid contacts the structure.

8. The apparatus of claim 1, wherein the structure is rigidly attached to an interior wall of the container.

9. The apparatus of claim 1, wherein the container and the structure are made of one or more biodegradable materials.

10. The apparatus of claim 1, wherein the container is made of one or more organic biodegradable materials.

11. The apparatus of claim 1, wherein the structure is made of one or more organic biodegradable materials.

12. The apparatus of claim 1, further comprising a lid that is bonded to the container.

13. The apparatus of claim 11, wherein the lid is made of one or more organic biodegradable materials.

14. The apparatus of claim 5, wherein the filter is made of one or more organic biodegradable materials.

15. A method for making a beverage container, the method comprising:
forming a container case;
adding a structure into the container case, the structure disposed the container case to change a direction of a fluid is provided to the container case; and
adding a beverage making material into the container case, wherein the fluid mixes with the beverage making material when the fluid is provided to the container case based on the changed direction of the fluid.

16. The method of claim 15, further comprising bonding a lid onto the container case such that the structure and the beverage making material are sealed within the container case.

17. The method of claim 15, further comprising placing the beverage making material into a filter that houses the beverage making material.

18. The method of claim 15, further comprising bonding the filter to a wall of the container case.

19. The method of claim 15, further comprising adding a support upon which the structure sits.

20. A method for making a beverage, the method comprising:
changing a direction of a fluid provided to a single-serve beverage pod by a structure included on an internal portion of the single-serve beverage pod when the fluid is provided to the single-serve beverage pod, wherein the fluid mixes with the beverage making material when the fluid is provided to the single-serve beverage pod based on the changed direction of the fluid and the mixing of the fluid with the beverage making material makes a beverage; and
outputting the beverage from the single-serve beverage pod.
